(19) United States
(12) Patent Application Publication
(10) Pub. No.: US 2017/0169399 A1
(43) Pub. Date: Jun. 15, 2017

(54) SYSTEM AND METHOD FOR VEHICLE PRICING

(71) Applicant: Shift Technologies, LLC, San Francisco, CA (US)

(72) Inventors: Irakly George Arison Areshidze, San Francisco, CA (US); Joel Washington, San Francisco, CA (US); Christian Michael Ohler, San Francisco, CA (US); Andrew Carman, San Francisco, CA (US); Tobias Schimmer, San Francisco, CA (US); Richard Stanton Sayler, San Francisco, CA (US); Tobias Russell, Alexandria, VA (US); Minneola Ingersoll, San Francisco, CA (US); Jonathan Vincent, San Francisco, CA (US); Watson Lu, San Francisco, CA (US); Lech Kaiel, Portland, OR (US); Craig John Isakow, Oakland, CA (US); Christina Melas-Kyriazi, San Francisco, CA (US); David Victor Galbraith, San Francisco, CA (US)

(21) Appl. No.: 15/379,364

(22) Filed: Dec. 14, 2016

Related U.S. Application Data
(60) Provisional application No. 62/267,027, filed on Dec. 14, 2015.

(51) Int. Cl. G06Q 10/10; G06Q 30/02; G07C 5/08

(52) U.S. Cl. CPC G06Q 10/1097; G07C 5/0841; G06Q 30/0283; G06Q 30/0201; H04L 67/12

(57) ABSTRACT

A system and method for managing a vehicle marketplace that includes managing a vehicle value data system comprising collecting vehicle value data from a set of vehicle data sources; receiving an initial vehicle pricing request; at an initial stage, generating a pricing report in response to the initial vehicle pricing request and at least partially based on analysis by the vehicle value data system; at a second stage, receiving a vehicle inspection report and updating the pricing report in response to the vehicle inspection report and analysis of the vehicle inspection report at the vehicle value data system; and providing the updated pricing report.

### CROSS-REFERENCE TO RELATED APPLICATIONS

This Application claims the benefit of U.S. Provisional Application No. 62/267,027, filed on 14 Dec. 2016, which is incorporated in its entirety by this reference.

### TECHNICAL FIELD

This invention relates generally to the field of car pricing, and more specifically to a new and useful system and method for vehicle pricing.

### BACKGROUND

Used-car marketplaces sometimes provide a tool to estimate the value of a vehicle. In a basic approach, the value of a used vehicle is derived from tabulated values that can be found by looking up basic features such as year, make, and model. Other approaches may allow a few more basic properties to be considered in generating a value estimate such as mileage. However, such approaches fail to provide a realistic expectation of a vehicle's value, as it matters to an owner. There can be large inconsistencies between reported market value and what a true potential sale price of the owner's vehicle. Thus, there is a need in the car pricing field to create a new and useful system and method for vehicle pricing. This invention provides such a new and useful system and method.

### BRIEF DESCRIPTION OF THE FIGURES

FIG. 1 is a schematic representation of a system of one embodiment;

FIG. 2 is a flowchart representation of a method of a first embodiment;

FIG. 3 is a schematic representation of an exemplary user interface used in a method of a preferred embodiment;

FIG. 4 is a schematic representation of a single stage update to the pricing report;

FIG. 5 is a schematic representation of a multiple stage update to the pricing report;

FIG. 6 is a schematic representation of an inspection report; and

FIG. 7 is a flowchart representation of a method of a second embodiment.

### DESCRIPTION OF THE EMBODIMENTS

The following description of the embodiments of the invention is not intended to limit the invention to these embodiments but rather to enable a person skilled in the art to make and use this invention.

### 1. Overview of a Method for Vehicle Pricing

A method for vehicle pricing of a preferred embodiment can include collecting vehicle state information and generating a vehicle value report. Collecting vehicle state information and generating a vehicle report is preferably performed at various stages, and the level of pricing detail can be refined at each stage. The pricing report of a particular stage can inform and influence progression in a process such as selling a car. The method can be applied to the sale of a vehicle, but can additionally or alternatively be applied to the maintenance and ownership of a vehicle over a prolonged duration (e.g., greater than one year). In addition to providing staged pricing estimation of a vehicle, the method may function to provide transparent pricing adjustments. A vehicle owner can see what aspects influence the price of a vehicle. The method can further provide vehicle pricing reports in association with a temporal component. For example, an expected vehicle sale price for a used car can be specified with a time window in which a minimum price is guaranteed for a vehicle owner.

As a first potential benefit, the method can be applied to better predictions of vehicle value. This can offer particular advantages to a vehicle marketplace. In one potential advantage, the vehicle marketplace can offer more competitive pricing that can incentivize a vehicle owner to sell a vehicle through that particular vehicle market because, for example, the other marketplace options offer less potential value. This can lead to more vehicle sales through the vehicle marketplace.

As another potential benefit of the method, a vehicle owner may maintain visibility into the sales process after the vehicle is left with the vehicle marketplace operator. Pricing adjustments can be presented to owners and even some listing options and strategies may be partially directed by an owner.

As related potential benefit of the method, the vehicle marketplace can accommodate automated vehicle sales strategies for different vehicles. In one variation, a vehicle listing strategy may be based on the type of car. For example, the method can treat a high-end vehicle different from a low end vehicle. In another variation, a vehicle listing strategy may be based on the priorities of a vehicle owner. When selling a vehicle, owners can have different priorities such as extracting the most value, getting a minimum amount of value, or selling as quickly as possible for example. The vehicle marketplace may enable a vehicle owner to select between different listing strategies in some cases.

As another potential benefit, the method may be used to strategically make vehicle updates to improve vehicle value. This can be used by a marketplace before listing a vehicle to try to increase the value extracted from a vehicle. The method preferably utilizes data analysis of maintenance costs, vehicle conditions, and sales data to generate predictions of the impact of particular maintenance tasks for various vehicles. This can alternatively be used during vehicle ownership in understanding when to sell a vehicle, when to trade-in a vehicle, and when to commit to various vehicle maintenance tasks (e.g., replacing parts).

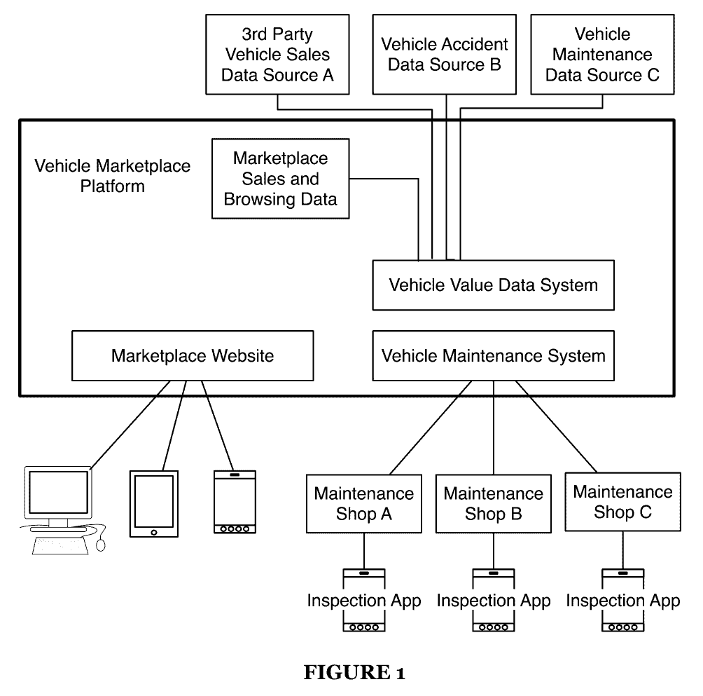

The method is preferably implemented through an online vehicle marketplace platform as shown in FIG. 1. The vehicle marketplace platform can host a website and/or the data system to support a variety of native user applications. The vehicle marketplace is preferably hosted in a remote cloud computing system, but can alternatively be hosted on any suitable computing infrastructure. The vehicle marketplace can be used in the sale of new and/or used vehicles. For example, the vehicle marketplace can include a variety of different vehicles that are presented and offered for sale. The vehicle marketplace may alternatively or additionally be used in the acquisition of used vehicles. For example, an owner can access the vehicle marketplace vehicle to initiate the sale of an owned vehicle to or through the online vehicle marketplace. The vehicle marketplace platform can operate in a variety of geographic regions with distributed operational capabilities. The method can collect data and operate in ways that leverage the vehicle pricing prediction capabilities of the method. The data driven nature of the vehicle marketplace platform can be used to enable various pricing capabilities and to automate various aspects of the platform such as list price adjustments, vehicle relocation, and vehicle maintenance.

In an alternative implementation, the method may be used with a vehicle maintenance platform, which can be operated with or without any association to an online or traditional vehicle marketplace. A vehicle maintenance platform is preferably used to generate informative reports on maintenance tasks. A vehicle maintenance platform may be used by a plurality of car/vehicle repair shops to provide customers or potential customers with estimates of expected vehicle costs in the future and to better communicate the value of repairs. For example, a mechanic could enter vehicle information and then generate a maintenance report showing the cost of fix, the expected impact on the value of the vehicle and scenarios relating to other predicted maintenance costs in the future. The vehicle maintenance platform may additionally provide other functionality relating to running a vehicle repair maintenance shop. Such maintenance reports could similarly be used when purchasing a used vehicle so that a potential buyer can understand expected near term future costs.

The online vehicle marketplace can additionally include a vehicle data management system, which functions to access, store, analyze, and/or otherwise utilize historical data relating to vehicle value. The vehicle data management system preferably interfaces with a plurality of vehicle data sources. Vehicle data sources can include transaction history on the vehicle marketplace, vehicle list prices on outside vehicle marketplaces, vehicle maintenance and/or accident history, and/or other suitable sources of information. The transaction history of the vehicle marketplace may be particularly useful since the state of the vehicle can be correlated to the sale of the vehicle.

Herein, the method is primarily described as it relates to the sale and/or maintenance of used cars, but the method can be used in selling, leasing, renting, or purchasing of new or used motorcycles, RVs, trailers, boats, planes, construction equipment, and/or any suitable type of vehicle. Additionally, one skilled in the art would also appreciate that variations of the method described herein may be used in any suitable manner including additional or alternative elements.

2. Method for Pricing during the Sale of a Vehicle

In one embodiment the method provides a pricing feedback process in facilitating a sale, which functions to enable a vehicle selling experience that is transparent to a vehicle owner (i.e., the seller). In particular, the method is applied in acquiring a vehicle from an owner for listing on a vehicle marketplace. Car owners are faced with many options when it comes time to selling an old vehicle. Many vehicle owners do not want to go through the hassle of selling a used car. Additionally, an individual is limited in the price that can be commanded when selling their car, and the process is burdensome to the individual. While potentially a simpler process, selling through a used car lot or a dealership introduces limited financial incentives for the original vehicle owner.

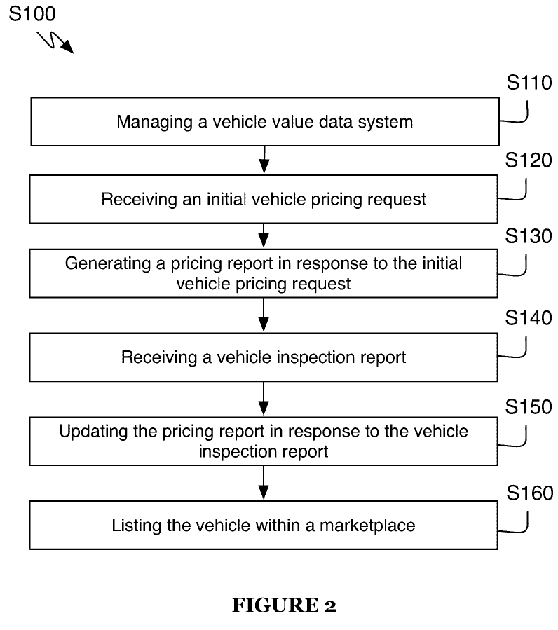

As shown in FIG. 2, a method S100 for pricing during the sale of a vehicle can include receiving an initial vehicle pricing request S120, generating a pricing report in response to the initial vehicle pricing request S130, receiving a vehicle inspection report S140, updating the pricing report in response to the vehicle inspection report S150, and listing the vehicle within a marketplace S160. As a first aspect, the method functions to incrementally provide pricing information so as to offer a different selling experience. As another aspect, the method functions to use a data-driven approach to analyzing vehicle pricing and the impact of vehicle maintenance to vehicle pricing. Accordingly, the method may additionally include managing a vehicle value data system S110. Using data-driven predictive techniques the method can reduce operating risk of the vehicle marketplace and increase the potential financial upside of the owner so as to attract more vehicle owners to the vehicle marketplace. As another aspect, the method functions to offer listing options in how different aspects of selling a vehicle are prioritized and/or how the financial arrangement of the marketplace and owner is structured. In one exemplary use case, the method can be used in a vehicle sales process wherein the owner can be provided a minimum guaranteed payout from the sale of the vehicle and a funds resulting from a sale price above the minimum payout are divided between the owner and the marketplace.

The method is preferably facilitated by an online vehicle marketplace platform. Initially a vehicle owner interested in selling a vehicle will access the vehicle marketplace platform through a native application (such as an app on a smart phone) or through a web application. The vehicle marketplace preferably helps the owner in facilitating the sell of the vehicle. When the owner decides to allow the vehicle marketplace to sell his or her vehicle, the vehicle can be placed in physical control of the marketplace. The vehicle may be transferred to a vehicle storage facility, car lot, or any suitable location by a representative (who may or may not perform a visual inspection as described below). Preferably, the vehicle undergoes a physical inspection wherein the pricing report can be refined. In some cases, the marketplace may selectively offer vehicle maintenance options that may have some impact on the listing of the vehicle. The vehicle owner may be presented with the option to perform maintenance tasks or note. When the vehicle is processed and ready to be listed, the vehicle is listed on the online vehicle marketplace. The vehicle may sell the vehicle to another outside party. In some scenarios the vehicle marketplace or another marketplace may acquire the vehicle. The method could additionally or alternatively be used by a traditional used-vehicle marketplace where the vehicle is also offered for sale on a car lot and the sticker price adjustments are reported and applied to the vehicle (electronically or manually). While the vehicle is listed, the pricing can be dynamically adjusted based on varying conditions such as updated vehicle sales history, vehicle demand, detected vehicle interest, duration of listing, a selected listing model, and/or any suitable aspect.

Block S110, which includes managing a vehicle value data system, functions to maintain a set of data records relating to vehicle sale history, vehicle maintenance records, vehicle driving records, and/or other forms of data. The vehicle value data system is preferably used at various stages of the method when generating value estimates of a vehicle and/or maintenance predictions. Managing vehicle value data system can include collecting vehicle value data from a set of vehicle data sources and/or analyzing the vehicle value data. The vehicle value data system preferably collects data from a variety of vehicle data sources. The vehicle data sources may provide general vehicle data or vehicle-specific data. General vehicle data preferably includes metrics for other vehicles that share common features such as company, model, year, color, package options, location, mileage, and/or other aspects. General vehicle data is preferably preemptively accessed and maintained. Vehicle-specific data sources preferably provides a data interface to records relating to a specific vehicle such as accident records or other car facts. The vehicle data sources can be accessed using a programmatic interface such as a third party application programming interface (API). The vehicle data source could alternatively be accessed through scraping, data uploads and/or other suitable approaches.

Vehicle sale history preferably relates to records of vehicle sales from the online vehicle marketplace and/or other marketplaces. They can include vehicle information like make, model, year, mileage, location, and the sale price. The vehicle sale history may be of the listing price of a vehicle, but could additionally or alternatively include the actual price at which the vehicle was purchased.

The vehicle maintenance records may include maintenance records from this and/or previous owners. The vehicle maintenance records may include details like mileage at particular maintenance appointments, oil change dates, tire rotations, part changes, vehicle repairs, vehicle recall updates, and/or other suitable information.

Vehicle driving records preferably provide information on any accidents or incidents involving the vehicle. In some cases, the vehicle driving records may include driving pattern data from third party sources. In one variation, vehicle driving records may relate to a particular vehicle and/or driver. In another variation, vehicle driving records may relate to a type of vehicle. For example, a vehicle maintenance platform may collect data on causes of vehicle damage, which can be used to understand how hard drivers are on different types of vehicles.

The vehicle value data system can additionally be internal data from the online vehicle marketplace. Managing a vehicle value data system in a vehicle marketplace can additionally include monitoring vehicle interest expressed through an interface of an online vehicle marketplace, which may be used in measuring demand. While vehicle data from outside sources may only expose tangible records relating to the sale of a vehicle. The data from the online vehicle marketplace can expose potential vehicle interest, which may be indicated through browsing patterns of potential buyers. For example, the number of views of a vehicle, the number of searches for particular vehicle parameters, the number of test drives requested, and/or other aspects. The online vehicle marketplace preferably includes a vehicle purchase marketplace for browsing vehicles that are for sale or use. Browsing patterns from this purchasing interface can be used in understanding vehicle interest, customer price sensitivity, vehicle demand, and/or other aspects relating to listing a vehicle.

Monitoring vehicle interest expressed through an interface of an online vehicle marketplace can include presenting a user interface and tracking user interactions. Presenting a vehicle-browsing interface can include providing search tools. Search tools can include result filtering tools, vehicle comparison tools, a vehicle saving feature, and/or any suitable feature. Presenting a vehicle-browsing interface could additionally or alternatively include providing a vehicle gallery. Other interface formats may additionally or alternatively be used. Tracking user interactions can include tracking navigation and interactions with the interface which may include tracking page views; scrolling and viewing content; mouse interactions with content; sharing, favoriting, or bookmarking a vehicle, and/or other suitable interactions.

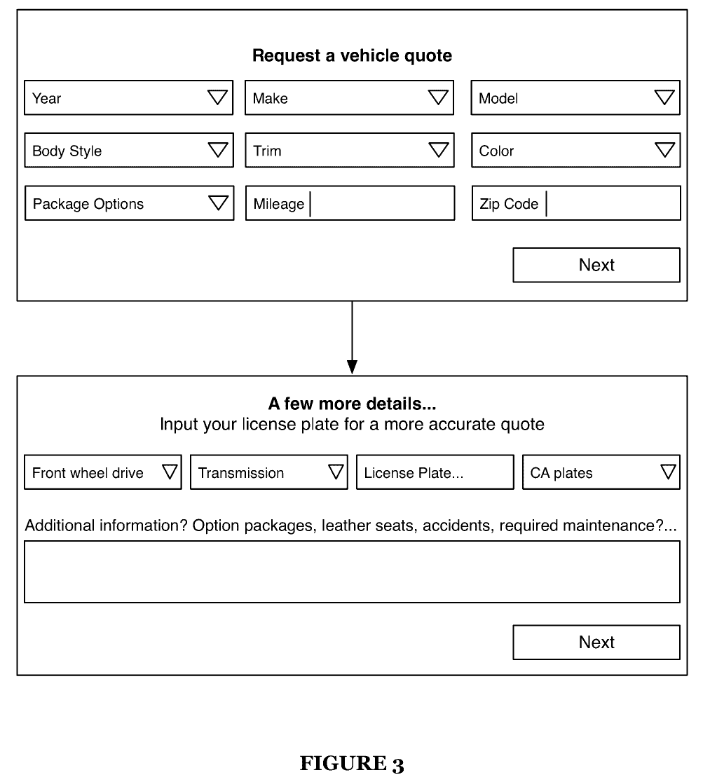

Block S120, which can include receiving an initial vehicle pricing request, functions to obtain owner supplied information. The initial vehicle pricing request is preferably received through a client device interface of the online vehicle marketplace. The vehicle pricing request preferably includes basic vehicle information such as the year, make, model, body style, trim, and mileage of the vehicle. The basic vehicle information can additionally include drive train (e.g., front wheel drive, four wheel drive, etc.), engine type, transmission type, color, condition, upgrades, history, and other suitable aspects. In another variation, information used to access vehicle specific information such as the vehicle identification number (VIN), license plate number, and/or driver's license number. In one variation, the basic vehicle information can be collected through a guided user interface which can dynamically request information based on previously supplied information as shown in FIG. 3. Vehicles can have different options and variations. The guided user interface can request information and supply appropriate vehicle options. For example, one car model may not come in a manual transmission option and so the transmission may not be requested or be automatically specified as automatic.

In the variation where the method S100 is used in combination with the method S200 described below, a vehicle maintenance record may be accessed and used in supplying vehicle information. In this variation, a user may simply select an option to request a pricing quote—the basic information and additional information may have previously been collected during maintenance session. For example, if the vehicle had previously been serviced at a qualifying car shop, then information may already be accessible. The associated records may be accessed using identifying information like the license plate number, and the owner can be alleviated from entering information.

The guided user interface may additionally dynamically generate relevant vehicle information queries that are generated based on the basic vehicle information. As the basic vehicle information is collected, vehicle value data system can be queried for specific variables that may have significant impact on the listing of the vehicle. For example, particular repairs or vehicle maintenance tasks may have a big impact on the. As another example, a vehicle's potential value may change if a vehicle has a clean air decal.

Additionally, the initial vehicle pricing request may include a selected listing option. The owner may present with a number of listing options. A listing option preferably characterizing parameters that characterize how a vehicle will be listed. In block S160, listing a vehicle can include setting a listing price according to one or more selected listing options. The listing option can specify priorities, constraints, and/or arrangements. In one variation, the vehicle marketplace can offer multiple listing arrangement options that characterize the structure of an agreement between the owner and the marketplace operator such as the fees and sharing of vehicle sales revenue.

An owner may be presented with a set of listing options including pricing options, timing options, and/or variables. For example, the minimum price value and/or the listing time window may be variables controlled by the owner. Adjustments of listing options are applied to an updated vehicle pricing agreement. An owner could set the listing options through an interactive user interface. In one scenario, an owner may need a faster sale and can set the listing time window to reflect that—the minimum price may be reduced to target a faster sale. In another scenario, an owner may not be sensitive to how long the sale takes and will want a higher sale price. The listing time window may increase to accommodate targeting the higher sale price. Such listing options and variables are preferably set through a user interface prior to listing the vehicle. However, the pricing options and variables may be configurable during listing. In one variation, a vehicle negotiation tool can be provided wherein a vehicle owner may be provided with various information such as listing traffic and/or purchase inquiries or bids. The negotiation tool can provide a simplified interface for an owner to simply guide a sale according to their preferences.

The listing arrangements options can include various models of owner-marketplace arrangements including: a guaranteed price model, a guaranteed price model with shared bonus, a fixed fee model, and/or any suitable model. Other listing arrangement options may relate to how a time window and pricing is adjusted. There could additionally be an option to define custom marketplace arrangement with user-defined rules and conditions of how price is adjusted.

A guaranteed price model can set a minimum price that is guaranteed to the owner. Preferably, a time window is designated, and if the vehicle is not sold in that time window, the owner can be transferred the guaranteed price. In a shared bonus variation of the guaranteed price model, the difference between the guaranteed price and the sale price may be split between the marketplace and the owner. The split could be a percentage or use any suitable approach to defining how that is split.

In a fixed fee model, the marketplace will take a fixed fee for selling the vehicle and the owner can take the difference between the sale price and the fixed fee.

A selected listing arrangement option may impact how prices are dynamically changed during listing in addition to how revenues are shared between multiple parties. Additionally or alternatively, a listing option can set priorities such as the time window of the transaction, the minimum price, maximizing the sale. Different owners may approach a vehicle sale with different objectives. The method can enable such prioritizes and objectives to be automatically translated into how a vehicle is listed in Block S160. Such listing options can additionally alter the generation of pricing reports. As with other information related to a vehicle, selected listing options can be altered at different stages. In some variations, the method can determine recommended listing options for particular scenarios and may make such recommendations. For example, an owner may initially specify they want to sell a car as quick as possible. After the inspection report, the condition of the car and the current market may result in a prediction that a 20% higher price can be achieved if given a longer time window. Such a recommendation can be presented to an owner.

Additionally or alternatively, vehicle information may be collected through non user input. In one example, the initial vehicle information (or vehicle information during a subsequent stage) is collected through an on-board diagnostics (OBD) tool. A vehicle data tool may be connected to a vehicle through an OBD port. Data and information is preferably collected and then can be communicated to the vehicle marketplace for generating or updating a pricing report. In some variations, data may be collected as the vehicle driven.

Block S130, which includes generating a pricing report in response to the initial vehicle pricing request, functions to provide a pricing estimate from the basic information. The initial pricing report is preferably provided to set initial expectations for selling the vehicle. The pricing report can specify the vehicle price as an expected range. The pricing report may additionally specify a minimum price, expected price, and an upper bound price. The pricing report may additionally specify a time window in which the owner could expect a sale to be completed. The initial pricing report is preferably based on a set of pricing data. The pricing data can include historical sales data, listing prices, auction prices, marketplace platform analytics, and/or other data sources. The data can be from one or more outside sources but may additionally or alternatively be sourced from the vehicle marketplace. The pricing report can additionally provide contextual information such as a projection of the future vehicle price. Presentation of listing options, predictions related to different listing options, and selection of listing options can additionally be included in the pricing report.

Preferably, the initial pricing report offers a non-committal step to selling a vehicle. Block S120 and S130 are preferably used so that a user can quickly obtain a quote from the online vehicle marketplace without needing to take a vehicle for an inspection. The owner can be presented with an option of proceeding to the next step in selling the car. If the owner does not find the vehicle price compelling, he or she may elect to not proceed. The owner can activate an option to proceed with selling the vehicle through the marketplace. Activating an option can include confirming the initial price record and/or scheduling a vehicle inspection. Upon receiving a request to proceed, a vehicle inspection request can be initiated internally. In one variation, a task is delegated to one or more workers to facilitate pickup and/or inspection of the vehicle. Optionally, the owner may transport the vehicle to a designated location, and a vehicle inspection can be initiated.

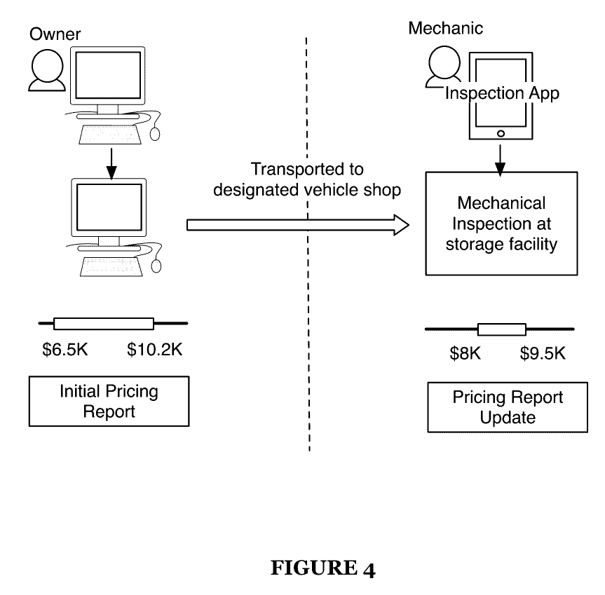

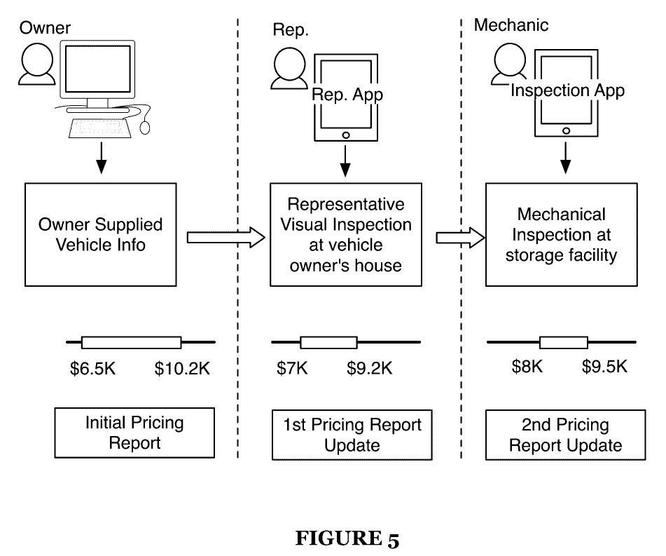

Block S140, which includes receiving a vehicle inspection report, functions to obtain additional detailed information about the vehicle from a trusted source. More generally the method may include receiving more updated vehicle information, which may include a received vehicle inspection report that confirms or modifies current vehicle information and/or supplements vehicle information. The vehicle inspection report could be a visual inspection by a marketplace representative, a third-party inspection, a mechanical inspection, or any suitable type of vehicle inspection. A vehicle inspection report could alternatively be performed by an owner of a vehicle. Additionally, multiple stages of vehicle inspection can be performed. In a first variation shown in FIG. 4, the vehicle is transported to a preparation facility which could be a marketplace managed facility or a third party facility such as a car shop. The owner may transport the vehicle. Alternatively, the vehicle marketplace may assign a vehicle transport task to a worker. The vehicle can undergo a detailed mechanical inspection at the preparation facility, and the pricing report can be updated through S150. A mechanical inspection can include checking various mechanical components such as the status of the engine and the brakes. In another variation shown in FIG. 5, a visual inspection performed by a marketplace representative can occur when a representative goes to pick up a vehicle. The visual inspection can be accompanied by a vehicle pricing adjustment through S150. In this variation the vehicle can be transported to a preparation facility as part of the next stage. The vehicle can undergo a more detailed mechanical inspection at the facility. The mechanical inspection can trigger another update to the pricing report through S150.

The vehicle inspection report provides additional details on the status of various components. The vehicle inspection report is preferably completed through a user interface, and the information is combined with the vehicle information provided in block S120 to form a vehicle profile. Vehicle inspection may be accompanied by maintenance and/or photographing the vehicle for selling through the marketplace. Receiving vehicle inspection report can include providing a vehicle inspection application user interface and collecting at least a portion of the vehicle inspection report through a set of inspection checks in the vehicle inspection user interface.

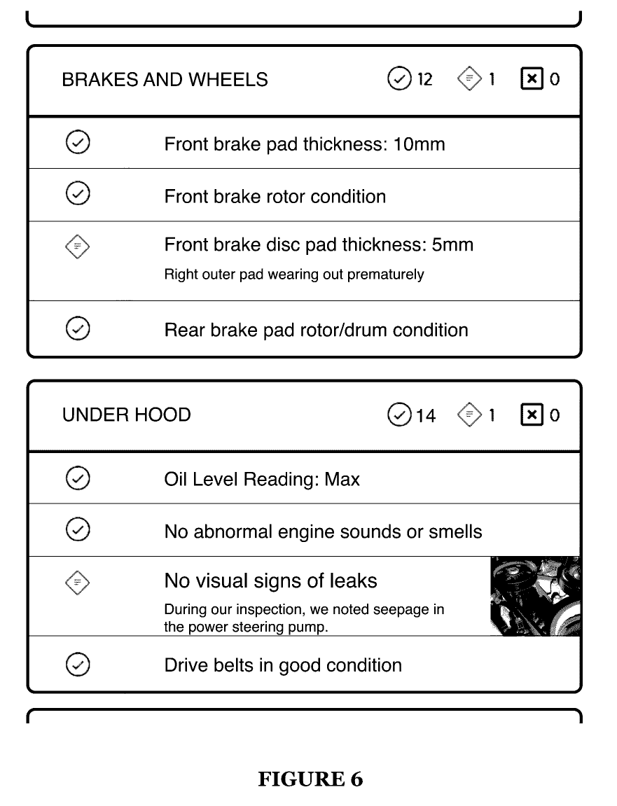

In one implementation, the inspection application guides one or more agents through an inspection of the vehicle. As mentioned above, the agent may be a trained technician, but the inspection application may additionally or alternatively be used by a general user such as a vehicle owner. A vehicle inspection report can provide status checks and information pertaining to various aspects of the vehicle as shown in FIG. 6. A vehicle inspection report can include information relating to: a stationary road test (e.g., functionality of lights, turn signals, horn, radio, and the like), a driving road test (automatic transmission shift quality, acceleration normal, abnormal sound check, steering wheel straight, and the like), an interior check (e.g., seat damage, seat belts, odor, floor mat condition, and the like), a body check (e.g., cosmetic damage to various parts), a brakes and wheels check (e.g., brake pad thickness, tire tread depth and condition, and the like), an engine and under the hood inspection (e.g., oil level, brake fluid level, battery condition, and the like), suspension condition, underbody (e.g., leaks and damage checks to the vehicle underside), and/or other suitable vehicle checks.

The inspection application preferably guides an inspector such that the inspection can be consistently performed regardless of the individual performing the inspection. The inspection application preferably facilitates easy entry of quantitative measurements such as tire tread depth or brake pad thickness and/or qualification checks such as part condition. For some checks, qualitative inspections may be automated using an inspection tool. For example, interior noise, vehicle vibrations, or other aspects may be measured using sensors of a smart phone or other suitable computing device. In other scenarios, qualitative inspections may be based on visual or auditory judgment by an inspector. The inspection application may provide references and/or guided questionnaires to help an inspector complete a consistent check. In one implementation, a vehicle inspection can be broken down into various checks that can be assigned a passing classification, an alert classification, or a notice classification. A passing classification may indicate that the vehicle passed that particular inspection check. An alert classification may indicate a particular problem or issue. A notice classification may not provide a judgment to a particular check but provide additional information highlighting some special condition of the vehicle.

Block S150, which includes updating the pricing report in response to the vehicle inspection report, functions to revise the pricing report. Updating the pricing report preferably provides greater resolution on the expected price. For example, an initial pricing report may provide a range for a minimum price, and the spread of the range may be reduced in response to the vehicle inspection report. The minimum price may alternatively be resolved to a fixed value. While the initial pricing report can provide an initial estimation of a listing strategy (e.g., sale price/range, time duration, and the like), the updated pricing report is preferably used to provide more resolution that can be used in settling a transaction agreement between the vehicle owner and the marketplace operator.

Updating the pricing report preferably includes processing the vehicle profile with basic information used in the initial pricing report and inspection information from the vehicle inspection report. The collected information can be analyzed using the vehicle value data system to generate a prediction of related to the sale of the vehicle. The prediction can include expected sales price, expected time windows, comparisons to other time windows or locations, and/or any suitable analysis. Data for similar vehicles or matching vehicles can be considered. The vehicle profile can include considerably more information than the basic information initially provided. Various price prediction heuristics and/or machine learning algorithms may be applied. In a first variation, the condition of the vehicle can be compared to vehicles of the same type. In another variation, the pricing trends of similar vehicles or earlier/later versions of a vehicle can be used in predicting price. In another variation, the pricing impact of various properties can be determined and applied to modeling the price of the vehicle. For example, the price impact of worn tire tread can be modeled across all types or classes of cars. The updated pricing report can additionally factor in sales data and trends through the marketplace. Additional factors such as marketplace cost of a sale including vehicle storage, vehicle test drive resources, insurance, relocation, and other costs can be factored into the pricing report.

The method can additionally include generating a vehicle maintenance recommendation, which functions to itemize maintenance tasks based on the impact on the price potential of the vehicle. The set of inspection checks that are at or below a quality threshold may be considered for fixing through vehicle maintenance. The cost of performing a maintenance task can be compared to the price impact of that particular item. A maintenance task can be recommended if performing the maintenance satisfies a condition of increasing the value of the vehicle. Maintenance tasks can include detailing, body work, part replacement, tire changes, engine repairs, and/or other maintenance tasks.

In one variation, the maintenance tasks can be assigned and carried out automatically by the marketplace operator. For example, low cost maintenance tasks with a large impact may be automatically scheduled and performed.

In another variation, the list of recommended maintenance tasks and the price impact can be delivered to the owner. The maintenance task assignment can be triggered upon receiving approval for one or more tasks by an involved party. The involved party can be the owner. The owner approval of a maintenance tasks preferably results in the scheduling of selected vehicle maintenance tasks prior to listing the vehicle within the marketplace. The involved party could alternatively be a buyer. A buyer may approve of a maintenance task as part of the purchasing process. The maintenance task can be scheduled to be performed prior to delivering the vehicle to the buyer. The recommended itemized maintenance tasks may be included in the updated pricing report. Details of the maintenance recommendations preferably specify the initial cost of the maintenance and an expected change in the sale price of the vehicle. After delivering a maintenance recommendation, the marketplace may receive owner approval for a subset of the vehicle maintenance recommendations, which are translated into execution of associated maintenance tasks. A vehicle owner can preferably select one or more maintenance recommendations through a user interface and submit them for execution. Alternatively, the vehicle owner may pass on all vehicle maintenance recommendations.

The method can include scheduling a selected vehicle maintenance task prior to listing the vehicle within the marketplace. After the vehicle inspection, the online marketplace platform can use a task management system to generate and deliver maintenance tasks. After the vehicle inspection, the vehicle may be temporarily stored before being listed. If one or more maintenance tasks are selected, then the appropriate workers can be notified of the requested maintenance on the vehicle.

The time frame of a sale can additionally be incorporated into the pricing report. The time window may be partially based on the time parameter specified by the owner in the initial vehicle pricing request. For example, the vehicle owner may specify if they want the vehicle sold as soon as possible, thirty days, or ninety days. The pricing report may include a predicted time frame for the vehicle. For example, the pricing report may report if the marketplace expects the vehicle to be sold in under the time window or to use the full time window. In one variation, a time frame recommendation may be generated, which functions to suggest a time frame that is more conducive to a better vehicle sale. As with the maintenance recommendation, the vehicle owner may be presented with the option to take the time frame recommendation.

In another variation, generating a pricing report can additionally include generating a relocation recommendation, which functions to suggest transporting the vehicle to a different location that would be more conducive for a vehicle sale. The vehicle sale records preferably include location information. In some cases, a vehicle may have significantly higher demand in a neighboring city, which may trigger a relocation recommendation. In a similar manner, the vehicle owner may be presented with an option to accept the relocation recommendation.

In yet another variation, the vehicle value data system may be used to simulate the vehicle sale performance using various listing options. The vehicle owner may or may not have selected a listing option at this stage. In both cases, a listing option recommendation may be presented to the vehicle owner. In some cases changing the listing option change the financial arrangement of the owner and vehicle marketplace.

In some scenarios, a vehicle may be expected to not sell or not sell for a suitable price, and the vehicle maintenance platform may decline the vehicle, in which case the vehicle is returned to the owner.

Block S160, which includes listing the vehicle within a marketplace, functions to sell the vehicle. A vehicle can be listed after receiving confirmation of a pricing report agreement. The pricing report agreement can specify the pricing guidelines for how a vehicle is listed and the terms of the arrangement between the owner and the marketplace. The terms agreement may be received along with the approval of maintenance task recommendations, input on time frame of the listing, response to a relocation recommendation, input for a listing strategy, and/or any suitable information to resolve the agreement. The vehicle is preferably listed based on the agreed terms of the pricing report. Listing the vehicle within a marketplace preferably includes the posting of the vehicle but can additionally include the listing period which includes duration for which the vehicle is on the vehicle marketplace. During the listing period, a vehicle may be marked as “coming soon”, “for sale”, “pending”, or marked with any suitable classifier.

Listing the vehicle includes listing a sale price with the vehicle. The sale price can be dynamically changed according to the price expectations. Dynamically changing the price can include transitioning the price over time, altering the pricing according to geographic regions, altering pricing according to a purchaser profile, and/or adjusting the price according to any suitable factor. Listing a vehicle additionally includes distributing vehicle information through the marketplace or other vehicle sales channels. For example, the vehicle with corresponding photos and information can be listed for sale on the online vehicle marketplace. Listing the vehicle can additionally include facilitating test drives, managing trade-ins, managing transaction, and/or other aspects involved in selling a vehicle. Preferably, the sale is executed as a sale between the owner and the purchaser. In another variation, the vehicle may be transferred to the marketplace and then the transaction is executed between the marketplace and the purchaser.

The listing price can be updated on the marketplace at least partially based on the selected listing option. When and how prices are adjusted may be driven by several factors one of them being constraints or objectives specified in a listing option. For example, if a short time window is set for a vehicle, then the price may be more quickly reduced over that time window to try to complete a sale before that time window expires. Similarly, the marketplace may utilize different approaches to price adjustments based on a selected listing arrangement option. How a vehicle's price is altered between a fixed fee and guaranteed price option may differ.

Listing the vehicle can additionally include notifying the vehicle owner of listing events, which may include information related to vehicle interest, price adjustments, market demand changes, and/or any suitable information. Vehicle interest may characterize the number of online views, test-drives, or other metrics for vehicle interest.

In a preferred variation, a final pricing report presents a minimum price point, a listing time window, and a projected value. The minimum price can be a guaranteed price if the vehicle is not sold within the listing time window. The marketplace delivers payment to the owner at the end of the listing time window for the minimum price if the vehicle is not sold. The projected value is the expected sale value of the vehicle.

In one listing arrangement option such as a guaranteed price model, the difference between the minimum price point and the actual sale price is split between the owner and the marketplace, which functions to incentivize the marketplace to obtain a higher sale price but also gives the owner a greater upside. Accordingly, the listing time window and the minimum price can be used in setting dynamic pricing of the vehicle.

Other suitable pricing arrangements may alternatively be used such as variable splits, flat fee, price range conditions, and/or other arrangements. In a variable split there could be a variable split between the owner and the marketplace based on the minimum price point, time window, and other factors. A flat fee arrangement may specify a fixed amount given to the marketplace for a sale. A price range condition could be an arrangement where if a vehicle is not sold within the price range and the time window, the vehicle listing is abandoned and the vehicle returned. For example, pricing an expensive sports car may be difficult since there are fewer transactions and potential buyers. The sports car may be initially listed at 150K and if the vehicle cannot be sold for more than 100K, the owner takes back the car.

3. Method for Pricing during Ownership

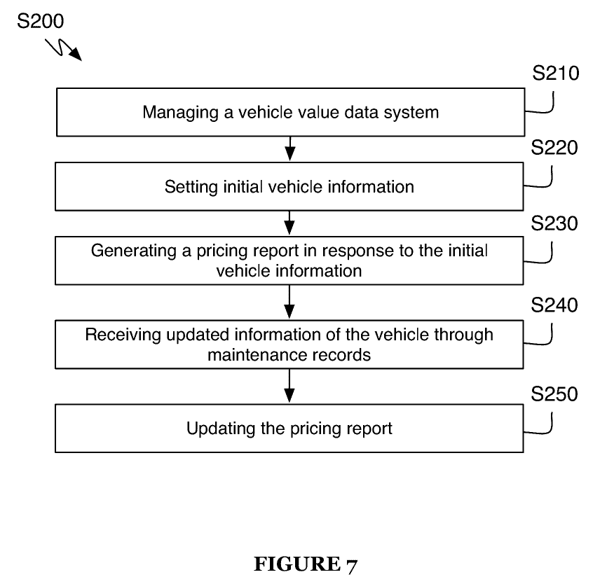

In another embodiment the method provides vehicle pricing feedback to augment the vehicle ownership process, which functions to apply vehicle pricing capabilities to other aspects of the car ownership experience. As shown in FIG. 7, a method 5200 for pricing during ownership can include managing a vehicle value data system S210, setting initial vehicle information S220, generating a pricing report in response to the initial vehicle information S230, receiving updated information of the vehicle through maintenance records S240, and updating the pricing report S250. As in the method S100 above, a correlation between maintenance, vehicle condition state and its timing, and vehicle value can be established. Variations of the methods S100 and S200 can preferably be used interchangeably and used in any suitable combination. The method functions to use various events during the ownership of a vehicle to incrementally build out information used in pricing a vehicle. Method S200 is preferably implemented by a vehicle maintenance platform. A plurality of vehicle maintenance shops preferably use the service offered by the vehicle maintenance platform. Vehicles visiting these participating shops can be entered in the system and used as a data point for other vehicles and/or benefit from generated pricing reports.

The method can be useful in helping an owner understand the value of a vehicle. It can additionally be used to show predicted maintenance costs and the impact of those maintenance tasks on a vehicle's value. This may be useful in deciding if optional maintenance should be performed. This may alternatively be useful in deciding when to sell a vehicle. In one variation, this may be applied by a company managing a fleet of vehicles. A rental car company, a shipping/delivery company, a taxi/rideshare company, and/or any suitable company with multiple vehicles could potentially benefit from receiving reports or viewing a dashboard reporting on. Method S200 could be used in budgeting vehicle maintenance costs for all vehicles and/or making adjustments to mitigate costs. In this implementation, method S200 is applied across a fleet of vehicles and a report on fleet value and/or costs can be generated.

The method S200 may additionally or alternatively be applied to augment or improve the pricing process when the owner decides to sell a vehicle. For example, an instant price quote may be supplied to an owner without supplying basic information or requiring a mechanical vehicle inspection, because sufficient vehicle information had been gathered through method S200. The method can additionally be used in maintenance notifications and/or recommended sale notifications.

Block S210, which includes managing a vehicle value data system, functions to maintain a set of data records relating to vehicle sale history, vehicle maintenance records, vehicle driving records, and/or other forms of data. Block S210 is preferably substantially similar to Block S110. Block S210 may have more data relating to maintenance as opposed to sales records. However, managing a vehicle value data system preferably includes collecting vehicle value data from a set of vehicle data sources, wherein at least one vehicle data source relates to maintenance costs and another to vehicle sale value. The maintenance costs and related data are preferably collected from multiple vehicle repair shops.

Block S220, which includes setting initial vehicle information, functions to create a vehicle information profile. A particular vehicle can be added to a tracking system of a marketplace. The vehicle can be a new car in which the statuses of various aspects of the car are well known. The vehicle may alternatively be a used car in which some information concerning the vehicle may be known. In some cases, the vehicle may have been processed previously by a former owner and so some information concerning the vehicle may be accessed and used. The vehicle information can include basic information such as year, make, model, body style, trim, mileage, drive train type (e.g., front wheel drive, four wheel drive, etc.), engine type, transmission type, color, condition, upgrades, history, and other suitable aspects. The vehicle information can additionally include mechanical maintenance information. For example, a vehicle may have a vehicle record created upon getting an oil change. The vehicle information can be entered and maintained through an internal system of a car shop, vehicle marketplace, car dealership, or any suitable establishment. For example, a mechanic may enter information during processing of the vehicle during a routine check-up. The vehicle information may alternatively be entered and maintained by an owner of the vehicle through an application.

Block S230, which includes generating a pricing report in response to the initial vehicle information, functions to provide pricing information. The pricing report may be substantially similar to the pricing report described above. For example, the pricing report may include an expected value range for which the vehicle may be sold for at this time. The pricing report may additionally project expected value as a function of time. The pricing report can additionally include information about expected maintenance costs and events or any suitable information.

Block S240, which includes receiving updated information of the vehicle through maintenance records, functions to monitor a vehicle over time. The updated information can be added to a vehicle profile and logged with a timestamp. As mentioned the method S200 can be implemented through a car shop where routine maintenance is performed. An internal system can be used to update the information. Alternatively, the method may be offered through a vehicle data platform, wherein a variety of car shops can supply updated vehicle information. The updated information may pertain to the type of work performed on a vehicle. Preferably the updated information can include the maintenance tasks relevant to that appointment such as an oil change, tire rotation, 50K mile checkup, and the like. The updated information may additionally or alternatively be information that can be gathered while the vehicle is being processed. A worker may add additional vehicle information such as mileage, part condition, or other details like in the inspection report described above. For example, the tire tread status may be updated despite the engine being worked on.

Additionally or alternatively, the updated information of a vehicle may come from a second vehicle, which functions to utilize the visits of similar vehicles to alter the expectations of a vehicle. For example, a first vehicle may have its initial vehicle information set during its only visit. However, if a plurality of vehicles of the same make model and year have come in to various car shops for similar issues it may be predicted that the first vehicle may soon experience such an issue.

Block S250, which includes updating the pricing report, functions to refine a prediction for price and cost of ownership. Preferably the pricing report is updated and delivered to the owner. The updated pricing report can additionally be used in informing maintenance decisions. Updating a pricing report may include generating a vehicle maintenance recommendation, which can help a vehicle owner understand the tradeoffs of various items of vehicle maintenance. An updated pricing report may additionally specify what factors contributed to a price change since the last pricing report. Price changes may be because of time of ownership, mileage, condition of different components, expected maintenance, and/or other factors.

Method 5200 may additionally include identifying a price trend event and notifying a vehicle owner of the price trend event. Notifying the vehicle owner can include sending a communication such as an email, phone call, text message, push notification, but could alternatively be a notification delivered through any suitable channel. A price trend can be a point in time when vehicle value undergoes some change. Preferably, significant negative changes in pricing of a vehicle are identified such that an owner can be notified so as to potentially sell a vehicle before the price drop. Identifying a price trend event preferably includes periodically recalculating price expectations of a vehicle. The modeling of a price can depend on the status of the particular vehicle and the sales data and trends seen within the marketplace and other sources. The cost of ownership can additionally be factored into the price trend event. Vehicle maintenance records are preferably used in identifying a price trend event. For example, maintenance records of particular cars may indicate that an HV battery replacement occurs commonly at a particular mileage or year of a hybrid car. The expected price may drop as the predicted timing of this event approaches, but upon replacing the battery the rate change in price slows down. Such predicted maintenance can be used in identifying a price trend and notifying a user to consider selling a vehicle.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method for managing a vehicle marketplace comprising:
managing a vehicle value data system comprising collecting vehicle value data from a set of vehicle data sources;
receiving an initial vehicle pricing request;
at an initial stage, generating a pricing report in response to the initial vehicle pricing request and at least partially based on analysis by the vehicle value data system;
at a second stage, receiving updated vehicle information and updating the pricing report in response to the updated vehicle information and analysis of the vehicle inspection report at the vehicle value data system; and
providing the updated pricing report.

2. The method of claim 1, wherein the updated vehicle information is a vehicle inspection report.

3. The method of claim 2, further comprising at a third stage, receiving a second vehicle inspection report and updating the pricing report in response to the second vehicle inspection report; wherein the vehicle inspection report is a visual inspection report and the second vehicle inspection report is a mechanical inspection report.

4. The method of claim 2, further comprising providing a vehicle inspection user interface and wherein receiving a vehicle inspection report comprises collecting at least a portion of the vehicle inspection report through a set of inspection checks in the vehicle inspection user interface.

5. The method of claim 2, further comprising generating at least one vehicle maintenance recommendation based on the vehicle inspection report.

6. The method of claim 5, wherein the vehicle maintenance recommendation provides a list of maintenance tasks and associated estimated value change.

7. The method of claim 5, further comprising receiving owner approval for a subset of the vehicle maintenance recommendations.

8. The method of claim 2, further comprising listing the vehicle within a marketplace.

9. The method of claim 8, wherein approval for the subset of the vehicle maintenance recommendations is received from an owner; and further comprising scheduling a vehicle maintenance task prior to listing the vehicle within the marketplace.

10. The method of claim 8, wherein approval for the subset of the vehicle maintenance recommendations is received from a buyer during a purchase process; and further comprising scheduling a vehicle maintenance task prior to delivering the vehicle to the buyer.

11. The method of claim 8, wherein the initial vehicle pricing request comprises a listing option.

12. The method of claim 11, and wherein listing the vehicle within a marketplace comprises setting a listing price at least partially based on the listing option.

13. The method of claim 11, wherein the listing option comprises a listing arrangement option selected from the listing arrangement options comprising a fixed fee option and a guaranteed price option.

14. The method of claim 11, wherein a listing option characterizes a time window of listing the vehicle.

15. The method of claim 1, wherein the initial vehicle information comprises vehicle information collected through an on-board diagnostics tool.

16. The method of claim 1, wherein listing the vehicle comprises notifying the vehicle owner of listing events.

17. The method of claim 1, wherein listing the vehicle comprises dynamically changing the vehicle price during a listing period.

18. A method for reporting vehicle value during vehicle ownership comprising:
managing a vehicle value data system comprising collecting vehicle value data from a set of vehicle data sources, wherein at least one vehicle data source relates to maintenance costs and another to vehicle sale value;
setting initial vehicle information;
generating a pricing report in response to the initial vehicle information;
receiving updated information of the vehicle through maintenance records; and
updating the pricing report.

19. The method of claim 18, wherein updating the pricing report comprises generating a vehicle maintenance recommendation that specifies the cost of a maintenance task.

20. The method of claim 18, further comprising identifying a price trend event and sending a notification to a vehicle owner of the price trend event.

21. The method of claim 18, further comprising providing a vehicle inspection user interface and wherein receiving a vehicle inspection report comprises collecting at least a portion of the vehicle inspection report through a set of inspection checks in the vehicle inspection user interface.

22. The method of claim 18, wherein the vehicle data source related to maintenance costs is a collection of maintenance data collected from multiple vehicle repair shops.
